(19) United States
(12) Patent Application Publication
(10) Pub. No.: US 2010/0083854 A1
(43) Pub. Date: Apr. 8, 2010

(54) METHOD FOR STARTING UP A WEB-FED ROTARY PRINTING PRESS

(75) Inventors: Daniel Burri, Konolfingen (CH); Thomas Zehnder, Laupen (CH)

Correspondence Address: RATNERPRESTIA, P.O. BOX 980, VALLEY FORGE, PA, 19482, US

(73) Assignee: WIFAG Maschinenfabrik AG, Bern (CH)

(21) Appl. No.: 12/444,273

(22) PCT Filed: Oct. 2, 2007
(86) PCT No.: PCT/EP07/60478

§ 371 Date: Sep. 21, 2009

(30) Foreign Application Priority Data
Oct. 4, 2006 (DE) 10 2006 046 894.5

(51) Int. Cl. B41F 13/54; B41L 3/08

(52) U.S. Cl. 101/228; 101/486

(57) ABSTRACT

A method for starting up a web-fed printing machine, in which a web to be printed on is guided through at least one printing gap formed by a printing cylinder and a counter printing cylinder of the web-fed printing machine; the printing cylinder accelerates to a print-on speed (Nₚᵣᵢₙₜ₋ₒₙ) in a position retracted from the web and is applied to the web; and at least during a partial phase of the acceleration of the printing cylinder, the web is stationary or is conveyed at an initial speed (Nᵢₙ) which is lower than the current speed of the printing cylinder.

This application is the U.S. national phase application of PCT International Application No. PCT/EP2007/060478, filed Oct. 2, 2007, which claims priority to German Patent Application No. DE102006046894.5, filed Oct. 4, 2006, the contents of such applications being incorporated by reference herein in their entirety.

### BACKGROUND OF THE INVENTION

1. Technical Field

The invention relates to a method for starting up a web-fed printing machine and to a web-fed printing machine comprising a control device configured for performing the method in accordance with the invention. The invention is preferably used in offset printing, either in dry offset or more preferably in wet offset. The printing machine can in particular be a newspaper printing machine, and therein in particular for printing large newspaper circulations.

2. Description of the Related Art

Starting up a web-fed printing machine at the beginning of a new production causes spoilage, in particular in phases in which the machine accelerates. At the beginning of the new production, the new web is drawn in by being drawn off from a reel changer by means of a drawing-in device, and guided via one or more drawing means and through one or more assigned printing units and through a turning device and a longitudinal folding device, up to a folding apparatus. The web is drawn in automatically, at least as far as the turning device. Once the web has been drawn in, the driven components of the machine, i.e. the reel changer, the drawing members for the web, the cylinders and rollers of the printing units and the folding apparatus, are accelerated synchronously. As long as no ink has yet been transferred onto the web, the start-up generates so-called white spoilage, and then in most cases also colour spoilage.

In order to avoid spoilage, EP 1 232 862 A1 proposes setting an inking profile which is specifically adjusted to the start-up. DE 10 2004 051 635 A1 reduces spoilage by specifically compensating for the cutting register error caused by acceleration processes. For sheet-fed printing, DE 100 57 051 A1 proposes that for starting up the printing machine after washing a rubber blanket, the rubber blanket is pre-inked. The subject of EP 0 830 943 A2 is a method for starting up or re-starting up the production run, likewise in a sheet-fed printing machine, in which the time for starting the running up of the printing machine, from a basic speed to the production speed envisaged for the production run, is set as a function of the number of machine revolutions necessary to convey a first sheet from a feeder stack to a predetermined position, such that after the sheet feed has been cut-in, a first sheet reaches the predetermined position inside the machine once or after the production speed is reached.

A method for avoiding spoilage is known from DE 10 2006 021 312 A1 which can be used in all offset printing machines and all indirect printing methods. Paragraph 0008 describes how at least one printing unit is started before the beginning of the printing operation, without transporting the printing substrate. Only once a stationary state of the ink in the printing unit has been reached is the printing substrate transport switched on, and the rubber blanket cylinder is applied to the printing substrate web which is now moving. This can be realised for a sheet-fed offset machine without any problems, whereas it is more difficult with web-fed machines, since in this case, the paper web has to be threaded through the individual printing units before printing begins. DE 103 11 219 A1 (D2) describes a method and device for printing on a web, wherein the printing material web 12 is guided through a printing gap formed by a rubber blanket cylinder 22 and a printing cylinder 26. The rubber blanket cylinder 22 is only partially covered with a rubber blanket in the circumferential direction, i.e. there would be a relative large unprinted region between two images transferred from the rubber blanket cylinder 22 onto the web 12. In order to avoid this, the speed of the web 12 is manipulated before it is fed in. This means that the rubber blanket cylinder 22 and the web 12 alternately exhibit the same or different speeds, wherein when the speeds are different, the speed of the web is always smaller than the constant rotational speed of the rubber blanket cylinder 22. A method for operating a web-fed machine is known from DE 100 14 535 A1, wherein the white, unprinted web is initially guided through the printing machine at a low speed, with the printing units retracted. When the printing web is running with the desired web tension, the printing units are switched to “print-on”.

### SUMMARY OF THE INVENTION

It is an object of the invention to provide a method using which it is possible to reduce the spoilage which is generated when starting up a web-fed printing machine, and to provide a web-fed printing machine on which said method can be used.

In one aspect, the invention provides a method for starting up a web-fed printing machine, in which a web to be printed on is guided through at least one printing gap formed by a printing cylinder and a counter printing cylinder of the web-fed printing machine. When starting up the machine, the printing cylinder is accelerated to a “print-on” speed in a position retracted from the web and applied—rotating at the print-on speed—to the web. Thus, during acceleration, the printing cylinder is not yet in contact with the web. The printing cylinder is preferably a printing blanket cylinder and can in particular be a rubber blanket cylinder. The counter printing cylinder can likewise be such a printing blanket cylinder, in order to be able to print on both sides of the web during the printing operation. In such embodiments, the counter printing cylinder is also accelerated to the print-on speed in a position retracted from the web and only then applied rotating at the print-on speed—to the web. The counter printing cylinder can, however, also be a cylinder which does not print, for example a steel cylinder, and can in particular be a central cylinder of a satellite printing unit, for example a nine-cylinder or ten-cylinder printing unit, comprising a number of assigned printing cylinders, preferably printing blanket cylinders. If the counter printing cylinder does not serve to transfer ink, it can already be in contact with the web while accelerating to the print-on speed, as will in particular be the case if the counter printing cylinder is a central cylinder for a number of ink-transferring printing cylinders. Printing is preferably already performed at the print-on speed; however, the ink transfer can in principle be delayed until an even higher speed has been reached.

In accordance with aspect of the invention, the web is not accelerated in synchrony with the printing cylinder, which is still retracted, when starting up the machine, but rather only after a delay. In a first variant of the method, the web is stationary and is only accelerated once the printing cylinder has reached the print-on speed or a lower speed which is preferably at least 50%, more preferably at least 80% of the print-on speed. In a second variant, the web is conveyed through the printing gap, which is still open, at an initial speed, preferably a constant initial speed, which is significantly lower than the print-on speed, while the printing cylinder is already being accelerated, wherein in an initial phase, the printing cylinder can be driven at a circumferential speed which corresponds to the initial speed of the web. Once the initial phase of such a synchronous run has been completed, the printing cylinder is run up to the print-on speed, while the web preferably continues to still be conveyed at the initial speed or is likewise already being accelerated continuously or in increments, but in any event more slowly than the printing cylinder. The initial speed can in particular correspond to a drawing-in speed at which the web is drawn into the printing machine automatically at least as far as a web drawing means downstream of the printing cylinder on the web path, by means of a drawing-in device. A web speed which corresponds to the print-on speed, at least to the extent that there is no fear of damage to the web when applying the printing cylinder, is likewise understood to also be a print-on speed for the web in both variants.

In preferred embodiments, a printing form cylinder is assigned to the printing cylinder. The assigned printing form cylinder serves to transfer ink onto the printing cylinder in accordance with the image. If the counter printing cylinder likewise serves to transfer ink onto the web, then a printing form cylinder for transferring ink in accordance with the image is likewise assigned to the counter printing cylinder in the same way.

The printing cylinder is assigned an inking unit, by means of which the ink is applied to the printing cylinder. If, as is preferred, the printing machine is a wet offset printing machine, the printing cylinder is also assigned a dampening unit for transferring moisture. If, as is preferred, the printing cylinder is assigned a printing form cylinder, the ink or the ink and the moisture is/are initially transferred onto the printing form cylinder and from there onto the printing cylinder. If the counter printing cylinder likewise serves to transfer ink, it or preferably its printing form cylinder on the other side of the web is likewise assigned an inking unit and preferably also a dampening unit. The respective inking unit preferably comprises at least one ink applying roller which can be applied to the assigned printing form cylinder or can be directly applied to and retracted from the printing cylinder. If the printing cylinder is also assigned a dampening unit, said dampening unit preferably comprises at least one moisture applying roller which can be applied to the assigned printing form cylinder or can be directly applied to and retracted from the printing cylinder. In an initial phase of the start-up, the ink applying roller and the optional moisture applying roller is/are advantageously retracted from the assigned printing form cylinder or printing cylinder. The rollers of the inking unit and optional dampening unit can therefore be accelerated separately from the printing cylinder and the optional printing form cylinder and applied to the relevant cylinder at a suitably selectable moment. Preferably, the optional dampening unit is applied before the inking unit and/or ink applying roller is applied.

On the basis of the starting-up sequence in accordance with the invention, it is possible to freely define the staggering, i.e. the sequential order when accelerating and when applying printing unit components to the respectively assigned component which is arranged nearer to the web. In particular, it is possible to extend the starting-up phase but still significantly reduce the white spoilage as compared to the conventional start-up methods.

The web has preferably already been drawn in before the start of the method, at least to the extent that it can be conveyed through the printing gap, which is still open, by means of one or more drawing means of the printing machine. Even more preferably, the web has already been completely drawn in, i.e. even into a folding apparatus of the printing machine, before the starting-up sequence in accordance with the invention is initiated by a machine controller. Once the web has been drawn in, the components of the printing machine which serve to convey the web are stationary in the first method variant, and are driven in accordance with the initial speed of the web in the second method variant. The initial speed is preferably constant as long as the printing cylinder and preferably also the other components of the printing unit are being accelerated to the print-on speed. The same applies to the counter printing cylinder, if it is likewise retracted from the web during the start-up. The components which serve to convey the web form a web conveying device. These components can in particular be one or more drawing rollers or comparable drawing means, and said folding apparatus and a driven reel changer. The printing machine features a control device which is configured such that it actuates the drives for the components which serve to convey the web, such that said components are either stationary or driven in accordance with the initial speed, during the start-up. The control device is also configured such that it simultaneously accelerates the printing cylinder and other driven components of the printing unit up to the print-on speed. The components which serve to convey the web are also actuated such that they accelerate the web to the print-on speed before the printing cylinder is applied. The web can already be accelerated while the printing unit components are being accelerated, but is preferably only accelerated once the printing unit components have already reached the print-on speed. If the counter printing cylinder likewise prints onto the web during the printing operation, then that which has been said with respect to the printing cylinder and its assigned components preferably applies in the same way to the counter printing cylinder and the other components which form part of the same printing unit as the counter printing cylinder.

To this end, the operator can preferably parameterise the applying/retracting sequence of the individual elements via a template, wherein the operator can conventionally define a rotational speed at which the element or elements, for example the dampening unit, the ink applying roller, the fluted roller and/or the moisture applying roller, begin(s) to move in the print-on direction. The operator can define the application of the individual elements, i.e. the applying speed and/or the applying time itself, according to length, optionally in metres or revolutions.

Each of the elements has an individual travelling time, i.e. an actual period of time which can be up to six seconds or more passes between actuation and the desired end state. It is therefore particularly preferred if the controller is configured such that it calculates the predetermined applying time for the element on the basis of the known period of time between actuation and application, which can for example be retrieved from a memory element of the controller, and controls the application process such that the element is applied at exactly the predetermined time X, i.e. if, for example, one of the elements requires a travelling time of two seconds, then the controller actuates said element at the time X-2 sec, in order for it to be applied at exactly the time X.

The print-on speed at which the printing cylinder is applied to the web can be the production run speed of the printing machine. More preferably, however, the applying print-on speed is lower than the production run speed. If, for example, the production run speed is in the range of between 40,000 and 50,000 revolutions per hour or even higher, the applying print-on speed can for example be selected from the range of 5,000 to 20,000 revolutions per hour, preferably from the range of 5,000 to 15,000 revolutions per hour. If, as is preferred, the printing cylinder has already been covered with ink in accordance with the image before being applied to the web, and is no longer accelerated further until the beginning of ink transfer, then printing also starts at the same time as applying. If the web is not stationary in the initial phases of applying the printing cylinder or cylinders assigned to it, but rather is itself conveyed at said preferably constant initial speed, then this initial speed is preferably in the range of between 200 revolutions per hour and 2,000 revolutions per hour, preferably at most 1,000 revolutions per hour. All the speeds mentioned relate to the circumferential speed of the printing cylinder at the given rotational speed.

In one development, the web is guided through a number of printing gaps, each formed by a pair consisting of one printing cylinder and one counter printing cylinder. If the counter printing cylinders are ink-transferring cylinders, the pairs of cylinders which respectively form a printing gap with each other can be arranged one above the other in a printing tower and can each form printing bridges with an assigned inking unit and optionally an assigned dampening unit, for example printing bridges in the shape of a “V” or an upside-down “V”. In this case, print-on is conventionally achieved sequentially, i.e. if four printing units are arranged one above the other, the uppermost bridge is applied first, two revolutions later the bridge below it, another two revolutions later the third bridge as viewed from above, and another two revolutions later the lowermost bridge, or vice versa. An important parameter for consecutively applying the printing units in an exact fit is the web tension, which should be taken into account. The result of such an applying sequence can then be seen as follows: the first four printed pages are only printed in black, the next four pages are printed in black and yellow, and so on, wherein printing begins at an arbitrary point on the printing web which is determined solely by reaching the print-on position of the cylinder, which is generally not the beginning of the page.

As already mentioned, however, it is also possible to provide a common counter printing cylinder for a number of printing cylinders, said counter printing cylinder forming a central cylinder of a satellite printing unit, for example a nine-cylinder or ten-cylinder satellite printing unit. It is in principle also possible to provide a non-ink-transferring counter printing cylinder for each of the printing cylinders. Lastly, it is also possible for two ink-transferring printing cylinders to be assigned to a common counter printing cylinder which in this case preferably likewise transfers ink, wherein the two assigned printing cylinders can be applied to the common counter printing cylinder alternately. In the number of printing gaps, the web can in particular be printed on in multiple colours. In accordance with the invention, that which has been said above with respect to only one pair consisting of a printing cylinder and a counter printing cylinder also applies in the same way to the other pairs of cylinders which each form a printing gap for the web and to the respectively assigned components for the transfer of ink and, optionally, moisture. In another development, the printing machine features printing cylinders and counter printing cylinders for a number of webs, preferably in order to each form a number of printing gaps per web. That which has been said above with regard to the start-up in accordance with the invention with respect to only one pair of cylinders also applies to these other printing cylinders and counter printing cylinders and their assigned components for the transfer of ink and, optionally, moisture. In such developments, the control device is configured such that all the components of the printing machine necessary for the respective printing production can be run up in the starting-up sequence in accordance with the invention. All the printing unit components can for example be accelerated synchronously. Alternatively, it is for example also possible to respectively accelerate only the printing cylinders and the preferably assigned printing form cylinders as a first group, the components of the inking units as a second group and the components of the optional dampening units as a third group, respectively in synchrony with each other, wherein a synchronous acceleration from group to group, i.e. an acceleration of the groups in synchrony with each other, need not occur. In principle, however, the starting-up sequence in accordance with the invention allows complete freedom in the manner, in particular the sequential order, of running up or applying the printing unit components.

The rotational angular position(s) of the printing cylinder(s) is/are set to a cutting register. If the counter printing cylinder(s) also perform(s) printing, the rotational angular position(s) of the counter printing cylinder(s) is/are likewise set to the cutting register. If at least one side of the web or at least one side of one of a number of webs is printed on in a number of colours, the printing cylinders or counter printing cylinders which print onto the relevant side of the web are set relative to each other in the colour register, i.e. the rotational angular positions of the relevant cylinders not only have to be set to the common cutting register but also to in-register printing relative to each other. During the start-up, the printing cylinder(s) and counter printing cylinder(s) and the web are therefore accelerated to the common print-on speed, up to the applying time, and the rotational angular positions of the printing cylinder(s) and counter printing cylinder(s) are, up to this time, set relative to each other in the sense of an in-register cut and preferably multi-coloured printing.

In preferred embodiments, the rotational angular position of the printing cylinder is set by accelerating the printing cylinder to a synchronising speed which is below the print-on speed and preferably near to the print-on speed, but in any event nearer to the print-on speed than to the initial speed of the web. The synchronising speed is preferably at least 80%, more preferably at least 90%, of the print-on speed. Within a synchronising phase, the printing cylinder is accelerated from the synchronising speed to the print-on speed. The web is likewise accelerated to the print-on speed within the synchronising phase. It is preferably already accelerated before the synchronising phase, and the acceleration is continued, preferably continuously, during the synchronising phase. The printing cylinder is accelerated beyond the synchronising speed, preferably also beyond the print-on speed, in a first partial phase of the synchronising phase, and retarded back down to below the print-on speed in a subsequent second partial phase, to a speed which the web exhibits at this time. This speed can in particular be the synchronising speed again. The second partial phase is followed by a third partial phase within which the web and the printing cylinder are jointly accelerated to the print-on speed.

The starting-up sequence—i.e. the speed, acceleration and respective start and end time of an acceleration of the web and the printing cylinder(s) and counter printing cylinder(s) up to the synchronising phase—is preferably initiated as a function of predetermined and preferably also measured speed values. The start and end times of accelerations are advantageously calculated by the controller, as a function of the speed values only.

In preferred embodiments, the rotational angular positions are set by means of detecting the rotational angular position of each printing cylinder or counter printing cylinder and comparing it with a detected position of the web. The rotational angular positions are preferably detected at said synchronising speed of the printing cylinder(s) or counter printing cylinder(s). In preferred embodiments, detection is followed by the synchronising phase described, within which the rotational angular position of each printing cylinder and counter printing cylinder to be set is set on the basis of the detected rotational angular position(s) and the detected position of the web.

If the position of a printing cylinder and its individual applying times are known, it is possible for the application time to be calculated by means of the controller such that the first contact between the printing cylinder and the printing web is at the beginning of the page, i.e. the paper is printed on for the first time at exactly the beginning of the page. It is also possible for all the printing points to be actuated by means of the controller such that the paper is printed on for the first time at the same location by all the printing points, i.e. the first printed page already exhibits all the colours, there are no pages only in black, only in black and yellow, and so on. Since, in this case, the web tension plays an important role and also has to be taken into account, it is particularly advantageous if the controller also takes on the function of capturing data for determining the web tension. These values should at least be available to it when calculating the print-on. In one development, the print-on times of a number of printing webs running within a printing machine are determined by the controller such that the paper is printed on at the same location by all the printing points on all the printing webs simultaneously, such that white copies emerge from the folding system at the end of the printing machine first and then—without any transition—completely printed copies, providing the feed in the turning tower allows this.

### BRIEF DESCRIPTION OF THE DRAWINGS

An example embodiment of the invention is described below on the basis of figures. Features disclosed by the example embodiment, each individually and in any combination of features, advantageously develop the subjects of the claims and the embodiments of the method and printing machine as described above. There is shown:

FIG. 1 a web-fed printing machine;

FIG. 2 a method in accordance with the invention, in a speed-time diagram; and

FIG. 3 a further development of the method in accordance with the invention.

### DETAILED DESCRIPTION OF THE PREFERRED EMBODIMENTS

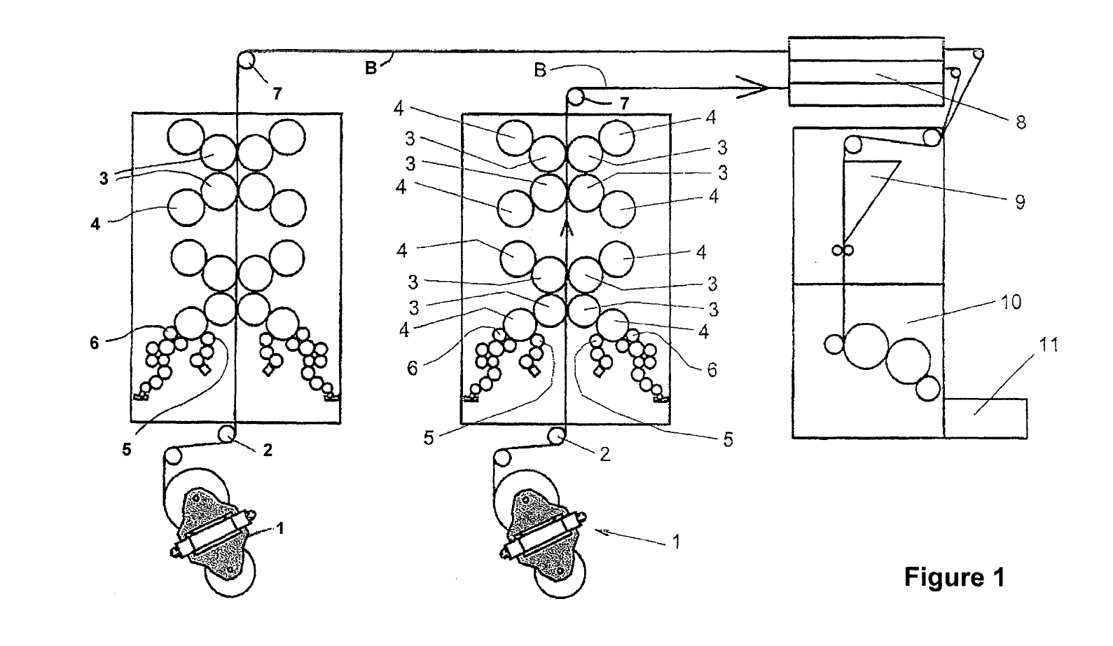

FIG. 1 shows an offset web-fed printing machine comprising a number of printing towers in each of which a web B of a printing material, preferably paper, is printed on each of its two sides in four colours. The webs unwind from reel changers 1. The printing towers, the paths of the webs B through the respective printing tower and the respectively assigned reel changer 1 are identical, such that reference is made in the following only to one of the webs B, as being representative of the others. The web B unwinds from a reel which is accommodated in the reel changer 1 for the web B. The reel changer 1 simultaneously accommodates two reels, namely the reel currently unwinding in the running production and another reel to be automatically exchanged once the unwinding reel has been used up. Via a drawing means 2 arranged at an inlet of the printing tower and a drawing means 7 arranged at an outlet of the printing tower, the web B is conveyed consecutively through four printing gaps arranged one above the other on the path of the web B between the drawing means 2 and 7 in the printing tower, and printed on.

In the printing tower, four printing units are arranged one above the other on each of the two sides of the web B. Each pair of printing units form a printing unit bridge. The printing units each comprise a printing cylinder 3, a printing form cylinder 4, a dampening unit 5 and an inking unit 6. The dampening units 5 and inking units 6 each comprise a number of rollers which are applied to each other for transporting moisture or ink. A moisture applying roller which is furthest upstream in the flow of dampening agent and an ink applying roller which is furthest upstream in the flow of ink can be applied to and retracted from the respectively assigned printing form cylinder 4. As viewed from the contact gap between the printing form cylinder 4 and the printing cylinder 3, the moisture applying roller of the respective printing unit contacts the printing form cylinder 4 before the ink applying roller of the same printing unit, as viewed in its rotational direction, such that in each revolution of the printing form cylinder 4, the moisture reaches the printing form cylinder 4 before the ink. The moisture applying rollers and the ink applying rollers can preferably be applied to and retracted from the respectively assigned printing form cylinder 4 independently of each other. To this end, each of the dampening units 5 and inking units 6 can be fitted with an actuating device of its own, which can be activated independently of the other actuating device in each case, such that the applying and retracting sequence can be controlled purely via signalling technology. Alternatively, however, it is also possible to provide a common actuating member for the dampening units 5 and inking units 6 per printing unit, wherein the moisture applying roller and the ink applying roller of the same printing unit are mechanically coupled to each other such that when the actuating member of the actuating device is actuated, the actuating member applies and retracts both the moisture applying roller and the ink applying roller via the mechanical coupling, in a sequential order which is predetermined by the mechanical coupling.

The printing cylinders 3 of the same printing unit bridge each form one of the printing gaps for the web B. In a position applied to the web B, they roll off on the web B and—via the web B—roll off on each other. The printing cylinders 3 thus each form a counter printing cylinder for the other printing cylinder 3 of the same printing unit bridge. For applying and retracting the printing cylinders 3, each of the printing units features an actuating device of its own comprising an actuating member, preferably an electric motor, which applies and retracts the respectively assigned printing cylinder 3 via a mechanical coupling. In the retracted position, the web B can be conveyed—free of the respectively retracted printing cylinder 3—through the printing gap which is then open. Preferably, the printing cylinder 3 in each of the printing units can be applied to and retracted from its counter printing cylinder 3, mechanically independently of the dampening unit 5 and the inking unit 6. Alternatively, however, it is perfectly possible for the printing cylinder 3 and the assigned moisture applying roller and the assigned ink applying roller for applying and retracting to be mechanically coupled to the same actuating member per printing unit and for the desired applying and retracting sequential order to be predetermined via the mechanical coupling. In a preferred applying sequence per printing unit, the moisture applying roller is applied to the printing form cylinder 4 in a first step and the ink applying roller is applied to the printing form cylinder 4 in a subsequent second step, before the printing cylinder 3 is applied to the counter printing cylinder 3 of the printing unit bridge in a third step.

A cylinder drive comprising a number of motors which are coupled to each other, not mechanically but rather merely via signalling technology, is provided for rotary-driving the cylinders 3 and 4 during printing, wherein each of said motors only drives one of the printing cylinders 3. Preferably, the relevant motor also drives the printing form cylinder 4 of the same printing unit. Preferred drive designs are described in EP 0 644 048 A2. In such embodiments, the printing cylinder 3 and the printing form cylinder 4 of each printing unit are mechanically coupled to each other. The dampening units 5 and the inking units 6 can be mechanically coupled to the motor of the assigned printing cylinder 3 and driven in tow by one of the cylinders 3 and 4 of the respective printing unit, preferably the printing form cylinder 4. Alternatively, it is also possible to provide a common motor, for rotary driving during printing, for the dampening units 5 and the inking units 6 per printing unit.

Once it has been printed on in the printing gaps of the printing tower, the web B is conveyed via the drawing means 7 out of the printing tower and towards a turning device 8. A cutting device, by means of which the web B is longitudinally cut into a number of partial webs, is arranged on the web path between the printing tower and the turning device 8. As an alternative to or in addition to a cutting device which is arranged between the printing tower and the turning device 8, a cutting device for longitudinally cutting can also be arranged between the reel changer 1 and the printing unit bridge immediately following the web path, such that the web B has already been longitudinally cut into partial webs when it is printed on. This can be advantageous, in particular for wide printing machines, for example printing machines which are six pages wide. Where only “the web B” is mentioned in the following with regard to printing, this is intended to include the scenario of printing onto previously formed partial webs.

The partial webs obtained by longitudinally cutting are turned or reversed in the turning device 8, merged to form a strand and conveyed through a longitudinal folding device 9, in which the strand is longitudinally folded. The longitudinal folding device 9 can in particular be a longitudinal folding funnel. If, as is preferred, the printing machine features a number of reel changers 1 and downstream printing towers in the manner of the printing tower described, in order to print on a number of webs simultaneously, then the partial webs obtained from the number of webs by longitudinally cutting are turned or reversed by means of the turning device 8 and merged towards the subsequent longitudinal folding device 9. The longitudinal folding device 9 can comprise a number of folding members, preferably folding funnels, in order to be able to form a number of longitudinally folded stitched strands from the partial webs, wherein partial webs which have been printed on in one of the printing towers can be merged with partial webs from another printing tower. The longitudinally folded stitched strands are conveyed into a folding apparatus 10 subsequent to the longitudinal folding device 9, transversely cut in the folding apparatus 10 and then transversely folded to form individual printed copies. The folding apparatus 10 delivers the printed copies on a copy delivery device 11 which conveys the delivered printed copies away.

In order to start a new production, for example a new daily production of a daily newspaper, the beginning of a new web B is unwound from the reel changer 1 and drawn in between and past the two printing cylinders 3 of the printing unit bridges via the drawing means 2, and towards the turning device 8 via the drawing means 7. Once the web B has been longitudinally cut, which can be performed between the drawing roller 7 and the turning device 8 or upstream of the printing tower or as applicable also partially upstream of the printing tower and partially only downstream of the printing tower if a corresponding longitudinal cutting device is provided, the partial webs are drawn in further around the turning bars of the turning device 8, merged to form one or more strands and drawn as a strand into the folding apparatus 10 via the longitudinal folding device 9. The web B, or partial webs which have already been formed from it upstream of the respective printing tower, are drawn in automatically, at least as far as the drawing means 7, by means of a drawing-in device. During drawing-in, the printing cylinders 3 each assume their position retracted from the web B, i.e. the web is guided through the printing gaps which are still open at this time. If a longitudinal cutting device is arranged downstream of the printing tower but upstream of the turning device, the web is preferably also automatically drawn in through the longitudinal cutting device by means of the drawing-in device. The web can likewise be drawn in automatically in and through the turning device 8 if a drawing-in device is provided for each of the partial webs, or the partial webs are drawn in through the turning device 8 manually. The strand or strands formed from the partial webs and as applicable the partial webs of other printing towers is/are drawn in through the longitudinal folding device 9, up to and into the folding apparatus 10.

While the web B or the partial webs formed from it is/are being drawn in, or preferably once the web B or the partial webs formed from it has/have been completely drawn in, the cylinders 3 and 4—which up until this time are preferably still stationary—and the dampening units 5 and inking units 6 are accelerated. The web is conveyed by means of the conveying means which are provided specifically for transporting the web, in particular by means of the drawing means 2 and 7. The reel changer 1 and the folding apparatus 10 also form part of the web conveying means. These web conveying means 1, 2, 7 and 10, and as applicable other web conveying means arranged on the web path, are driven synchronously, wherein the web conveying means, for example the drawing means 2 and 7 at the inlet and outlet of the printing tower, are advantageously driven at speeds which are slightly different from each other, in order to set a desired web tension. During this start-up of the printing machine, the printing cylinders 3 are applied to the web B and the moisture applying rollers and ink applying rollers are applied to the respectively assigned printing form cylinder 4 in a predetermined starting-up sequence.

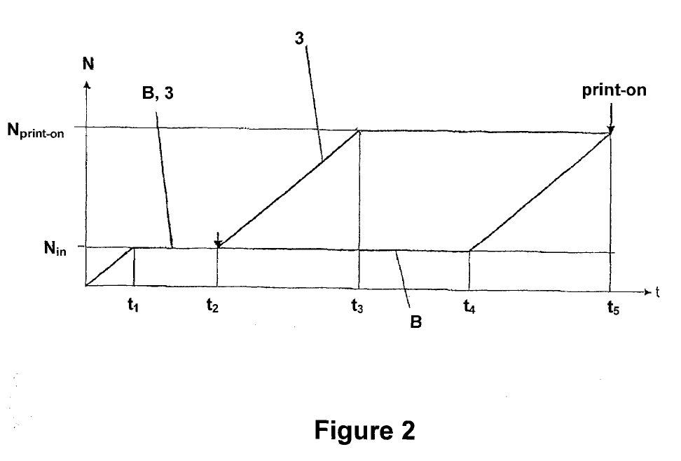

FIG. 2 shows a starting-up sequence in a speed-time diagram. The speed is plotted as the rotational speed N of the printing cylinders 3. At the beginning of the starting-up sequence, the web conveying means 1, 2, 7 and 10, the cylinders 3 and 4 and the rollers of the dampening units 5 and inking units 6 are accelerated up to a drawing-in speed Nᵢₙ, up to a time t₁. The web B then continues to be conveyed at the drawing-in speed Nᵢₙ, if it has already been completely drawn in, or is firstly completely drawn in, wherein the driven components of the printing machine are driven at a speed which corresponds to the speed Nᵢₙ, of the printing cylinders 3. After this first phase of a synchronous run at the constant speed Nᵢₙ, the printing cylinders 3 which are still retracted, the printing form cylinders 4 and the rollers of the dampening units 5 and inking units 6 are accelerated to a print-on speed Nₚᵣᵢₙₜ₋ₒₙ from a time t₂ to a time t₃, preferably at a constant acceleration. Unlike conventional start-up methods, the web B is conveyed at an initial speed Nᵢₙ which is significantly lower than the print-on speed Nₚᵣᵢₙₜ₋ₒₙ while the printing units are being accelerated. The initial speed Nᵢₙ advantageously corresponds to a speed which the printing cylinders 3 exhibit at their circumference at a few hundred revolutions per hour, for example at a circumferential speed of 300 revolutions per hour up to about 1000 revolutions per hour, at most 2000 revolutions per hour, and preferably at about 500 revolutions per hour. In the example embodiment, it corresponds to the drawing-in speed. The print-on speed Nₚᵣᵢₙₜ₋ₒₙ, by contrast, is preferably at a rotational speed of the printing cylinders 3 of at least 5000 revolutions per hour, but on the other hand significantly below the production run speed. The print-on speed is typically about 10,000 revolutions per hour. It should not exceed 20,000 revolutions per hour.

The web B is accelerated only after a delay as compared to the printing units 3, 4, 5, 6. Once the driven components of the printing units have reached the print-on speed Nₚₒᵢₙₜ₋ₒₙ at the time t₃, they continue to be driven at the constant print-on speed Nₚₒᵢₙₜ₋ₒₙ, the web B and the partial webs formed from it, by contrast, continue(s) to be run at the low initial speed Nᵢₙ by the machine. The driven components of the printing units run freely during this time, i.e. the bearings and gears are uniformly lubricated after free-running, and the speed of the relevant components has been set to the constant speed value Nₚₒᵢₙₜ₋ₒₙ. As long as the printing cylinders 3 are still retracted from the web B, the moisture applying rollers and ink applying rollers which are driven in synchrony with the cylinders 3 and 4 are applied to the respectively assigned printing form cylinder 4. The starting-up sequence is in principle arbitrary; preferably, however, the moisture applying rollers are applied first and only then the ink applying rollers. In any event, the driven components per printing unit are running synchronously and the printing units are also running in synchrony with each other, at the speed Nₚᵣᵢₙₜ₋ₒₙ, at the time t₅.

The web B continues to be driven at the initial speed Nᵢₙ up to a time t₄ which is before the time t₅. As soon as the time t₄ has been reached, the web B is accelerated, i.e. the web conveying means 1, 2, 7 and 10 are accelerated, preferably at a constant acceleration which—as in the example embodiment—can be just as large as the acceleration of the printing units in the time interval from t₂ to t₃. The web B is accelerated up to the print-on speed Nₚᵣᵢₙₜ₋ₒₙ. As soon as the web B has reached the print-on speed Nₚᵣᵢₙₜ₋ₒₙ, and after waiting for the web speed Nₚᵣᵢₙₜ₋ₒₙ to stabilise as applicable, the printing cylinders 3—which are still running at the print-on speed Nₚᵣᵢₙₜ₋ₒₙ—are applied to the web B. They are applied at the time t₅, indicated as “print-on” in the diagram.

In the time interval between the beginning of acceleration and the “print-on” time, i.e. in the time interval from t₂ to t₅, and in particular in the time interval from t₃ to t₅, the printing units are preferably not only running freely but are also already being supplied with moisture and ink, preferably such that a state of equilibrium has been set between the moisture reservoir and the printing cylinder 3 and the ink reservoir and the printing cylinder 3 of the same printing unit in each case with regard to transporting moisture and ink.

The starting-up sequence is stored in a control device of the printing machine in the form of nominal speed values and nominal acceleration values. The control device calculates the start and end times of the acceleration phases from measured speeds. However, since the acceleration of the printing units cannot be changed in jumps, for example from zero to a particular value, a “slide” is generated in the transition phases, such as is qualitatively shown for the change in acceleration at t₂. Inaccuracies in the rotational angular positions of the printing cylinders and counter printing cylinders 3 are generated as a result of the slide.

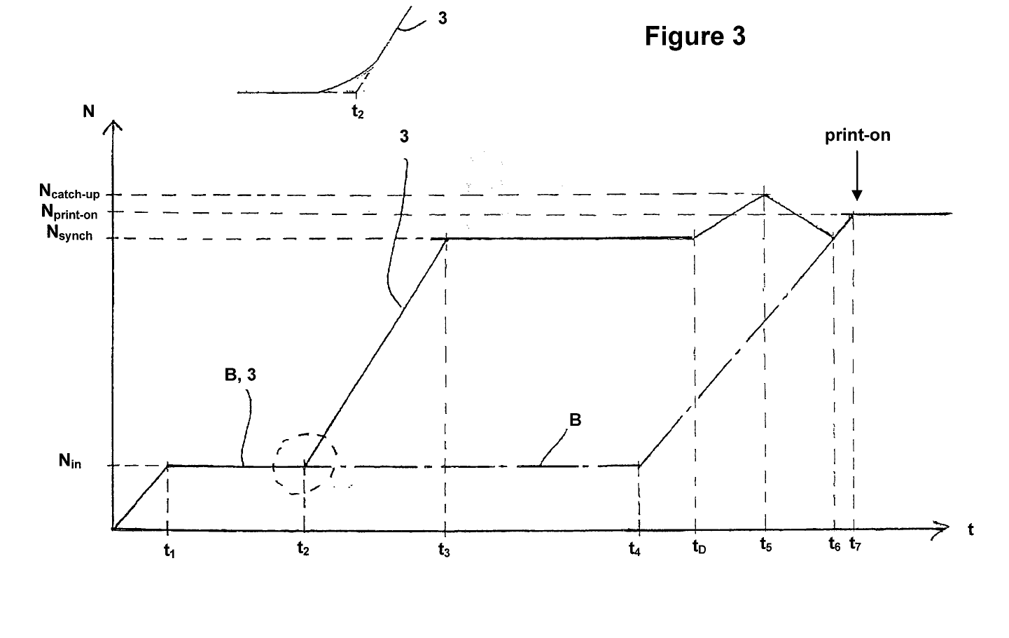

FIG. 3 shows a further developed starting-up sequence in which the rotational angular positions are set in a synchronising phase. The further developed starting-up sequence corresponds to the described starting-up sequence up to the time t₂ and also during most of the acceleration phase from t₂ to t₃. The printing units are not however accelerated to the print-on speed Nₚᵣᵢₙₜ₋ₒₙ in this acceleration phase, but rather only to a slightly lower synchronising speed N_{synch}, and held at the synchronising speed N_{synch} while the web B continues to be conveyed at the initial speed Nᵢₙ, and is accelerated from the time t₄, preferably at a constant acceleration, to the print-on speed Nₚᵣᵢₙₜ₋ₒₙ. With regard to the web B, the starting-up sequence of FIG. 3 corresponds to the starting-up sequence of FIG. 2.

In order to set the rotational angular positions of the printing cylinders and counter printing cylinders 3 with regard to the cutting register and colour register, the position of the web B and the rotational angular positions of the printing cylinders and counter printing cylinders 3 or of the printing form cylinders 4 are detected and compared with each other at a time t_{D}, shortly after the web B is accelerated, i.e. shortly after the time t₄. At the time t_{D}, the cylinders 3 and 4 are rotating at the constant synchronising speed N_{synch}. The rotational angular positions are set on the basis of the comparison in the synchronising phase subsequent to the time t_{D}. The web B takes on the function of a leading axis for the printing cylinders and counter printing cylinders 3 assigned to it. The synchronising phase is sub-divided into a number of partial phases. In a first partial phase, the cylinders 3 are accelerated to a catch-up speed N_{catch-up} which is preferably greater than the print-on speed Nₚᵣᵢₙₜ₋ₒₙ. Once the cylinders 3 have reached the catch-up speed N_{catch-up}, they are retarded to the current speed of the web B in a second partial phase from a time t₅, preferably back to the synchronising speed N_{synch}. They have reached the same speed as the web B at a time t₆ and are then accelerated substantially in synchrony with the web B to the print-on speed Nₚᵣᵢₙₜ₋ₒₙ in a third partial phase. At a time t₇, the web B and the printing units have reached the print-on speed Nₚᵣᵢₙₜ₋ₒₙ and are stabilised at this speed, before the printing machine as a whole continues to accelerate until finally the production run speed has been reached.

The inaccuracies in the rotational angular positions of the cylinders 3 which are caused by the changes in acceleration up to the time t_{D} are corrected in the two partial phases from t_{D} to t₆. In the third partial phase from t₆ to t₇, additional fine corrections are made to the rotational angular positions which are generated by the slide of the web B when reaching the print-on speed Nₚᵣᵢₙₜ₋ₒₙ.

In a preferred embodiment, the control device calculates the time t₆ at which the web B reaches the synchronising speed. It is calculated in the phase in which the web B is accelerated from the initial speed Nᵢₙ, either already before or immediately after the actual positions of the web B and the cylinders 3 are detected. The control device preferably also calculates, on the basis of the positions of the web B and the cylinders 3 as detected at the time t_{D}, the actual rotational angular positions which the cylinders 3 would assume at the time t₆ if they continued to be rotated constantly at the synchronising speed N_{synch}. A nominal rotational angular position for each of the cylinders 3 for the time t₇ results from the detected position of the web B. The individual deviation per cylinder 3 between the actual rotational angular position and the nominal rotational angular position is compensated for by “catch-up”, by accelerating the cylinders 3 and the respectively assigned components 4, 5 and 6 from the synchronising speed N_{synch} to the catch-up speed N_{catch-up} in the two partial phases from t_{D} to t₅ and from t₅ to t₆, and retarding them back to the synchronising speed N_{synch}. The first partial phase and the second partial phase are preferably of equal length.

The control device is connected via signalling technology to the actuating devices of the printing units, in particular to the actuating device for applying and retracting the printing cylinders 3, and to the drive devices, i.e. the cylinder drives and as applicable the other drives for the printing units and the drives for the web conveying means, in particular a drawing means drive for the drawing means 2 and a drawing means drive for the drawing means 7 and a drive for the folding apparatus 10 and a drive for the reel changer 1, in order to actuate the actuating devices and drives in accordance with the starting-up sequence, respective using a guiding variable. As described by way of example, the starting-up sequence is preferably performed in speed increments. The respective start speed and the respective end speed per acceleration phase are stored in a memory of the control device. In the simple starting-up sequence of FIG. 2, the speeds Nᵢₙ, and Nₚᵣᵢₙₜ₋ₒₙ in particular are stored. In the further developed example embodiment, the speeds N_{synch} and N_{catch-up} are additionally stored. The accelerations for the individual acceleration phases are also predetermined as nominal values in both example embodiments, each preferably as a fixed nominal value per phase. The times tᵢ, and in the further developed example embodiment also the time t_{D}, are preferably calculated as a function of representative readings, i.e. detected speeds and positions. In the further development, the rotational angular positions are set by a comparison with the detected position of the web. Alternatively, however, the rotational angular positions of the printing cylinders 3 or printing form cylinders 4 can also be set on the basis of a comparison with a detected rotational angular position of a leading axis of the printing machine, for example the axis of a cylinder of the folding apparatus 10.

1-23. (canceled)

24. A method for starting up a web-fed printing machine comprising:
guiding a web to be printed on through at least one printing gap formed by a printing cylinder and a counter printing cylinder of the web-fed printing machine;
accelerating the printing cylinder to a print-on speed (Nₚᵣᵢₙₜ₋ₒₙ) in a position retracted from the web and applying the printing cylinder to the web;
wherein at least during a partial phase of the acceleration of the printing cylinder, the web is stationary or is conveyed at an initial speed (Nᵢₙ) which is lower than the current speed of the printing cylinder.

25. The method according to claim 24, wherein the web is accelerated to the print-on speed (Nₚᵣᵢₙₜ₋ₒₙ) while the printing cylinder is still in its retracted position, and the printing cylinder is only applied to the web once the web has reached the print-on speed (Nₚᵣᵢₙₜ₋ₒₙ).

26. The method according to claim 24, wherein the printing cylinder is accelerated to a synchronising speed (N_{synch}) which at least substantially corresponds to the print-on speed (Nₚᵣᵢₙₜ₋ₒₙ), and the web is only accelerated from being stationary or from the initial speed (Nᵢₙ) once the printing cylinder has reached the synchronising speed (N_{synch}).

27. The method according to claim 24, wherein the printing cylinder is only accelerated on the basis of a predetermined speed profile, up to a synchronising speed (N_{synch}) which at least substantially corresponds to the print-on speed (Nₚᵣᵢₙₜ₋ₒₙ).

28. The method according to claim 24, wherein a position of the web and a rotational angular position of the printing cylinder are detected by means of a sensor device, and the rotational angular position of the printing cylinder is set as a function of the detected position of the web.

29. The method according to claim 24, wherein:
the printing cylinder is accelerated to a synchronising speed (N_{synch}) which at least substantially corresponds to the print-on speed (Nₚᵣᵢₙₜ₋ₒₙ);
the web is accelerated to the synchronising speed (N_{synch});
the web and the printing cylinder are jointly accelerated from the synchronising speed (N_{synch}) to the print-on speed (Nₚᵣᵢₙₜ₋ₒₙ);
a rotational angular position of the printing cylinder is set relative to a position of the web during the common acceleration, wherein the rotational angular position and the position of the web are preferably detected; and
the printing cylinder which is set in its rotational angular position is applied to the web at the print-on speed (Nₚᵣᵢₙₜ₋ₒₙ).

30. The method according to claim 24, wherein:
the printing cylinder is accelerated to a synchronising speed (N_{synch}) which at least substantially corresponds to the print-on speed (Nₚᵣᵢₙₜ₋ₒₙ);
the printing cylinder is accelerated from the synchronising speed (N_{synch}) to a catch-up speed (N_{catch-up}) before it is applied to the web, and the web is accelerated to an increased web speed;
the printing cylinder is retarded from the catch-up speed (N_{catch-up}) to the increased web speed; and
a rotational angular position of the printing cylinder during the phase of being accelerated to the catch-up speed (N_{catch-up}) and retarded to the increased web speed (N_{synch}) is set relative to a position of the web, wherein the rotational angular position and the position of the web are detected.

31. The method according to claim 30 wherein the increased web speed is equal to the synchronising speed (N_{synch}).

32. The method according to claim 28, wherein the rotational angular position at the synchronising speed (N_{synch}) of the printing cylinder and the position of the web are detected while the web is accelerating to the synchronising speed (N_{synch}).

33. The method according to claim 28, wherein the synchronising speed (N_{synch}) is at least 80% of the print-on speed (Nₚᵣᵢₙₜ₋ₒₙ).

34. The method according to claim 24, wherein the initial speed (Nᵢₙ) of the web at least substantially corresponds to a drawing-in speed for automatically drawing in the web or to a configuring speed for synchronising cylinders and rollers of the web-fed printing machine which are necessary for printing.

35. The method according to claim 24, wherein the print-on speed (Nₚᵣᵢₙₜ₋ₒₙ) is at least five times as large as the initial speed (Nᵢₙ).

36. The method according to claim 24, wherein the print-on speed (Nₚᵣᵢₙₜ₋ₒₙ) corresponds at least to a circumferential speed of the printing cylinder which the printing cylinder exhibits at 5000 revolutions per hour at its outer circumference which contacts the web during printing.

37. The method according to claim 24, wherein:
in a position retracted from the web, the counter printing cylinder is accelerated to the print-on speed (Nₚᵣᵢₙₜ₋ₒₙ) and is only applied to the web once it has reached the print-on speed (Nₚᵣᵢₙₜ₋ₒₙ); and
at least during a partial phase of the acceleration of the counter printing cylinder, the web is stationary or is conveyed through the printing gap at the initial speed (Nᵢₙ).

38. The method according to claim 24, wherein an ink applying roller which is assigned to the printing cylinder is accelerated before it is applied to the web and is only applied to the printing cylinder or a printing form cylinder assigned to the printing cylinder once it has been accelerated.

39. The method according to claim 38, wherein the ink applying roller is applied to the printing cylinder or a printing form cylinder assigned to the printing cylinder only once it has been accelerated to the print-on speed (Nₚᵣᵢₙₜ₋ₒₙ).

40. The method according to claim 24, wherein a moisture applying roller which is assigned to the printing cylinder is accelerated before it is applied to the web and is only applied to the printing cylinder or a printing form cylinder assigned to the printing cylinder once it has been accelerated.

41. The method according to claim 40, wherein the moisture applying roller is applied to the printing cylinder or a printing form cylinder assigned to the printing cylinder only once it has been accelerated to the print-on speed (Nₚᵣᵢₙₜ₋ₒₙ).

42. The method according to claim 24, wherein ink, alone or with moisture, is transferred onto the printing cylinder before it is applied to the web, and the printing cylinder is preferably only applied to the web once a state of equilibrium between the ink taken up and the ink dispensed has been set with regard to the ink transfer between the printing cylinder and an assigned inking unit.

43. The method according to claim 24, wherein the web is guided consecutively through a number of printing gaps, each formed by a printing cylinder and a counter printing cylinder.

44. The method according to claim 24, wherein:
a number of webs are each guided through at least one printing gap formed per web by a pair of a printing cylinder and a counter printing cylinder, assigned to the respective web;
the printing cylinders are each accelerated to the print-on speed (Nₚᵣᵢₙₜ₋ₒₙ) in a position retracted from the assigned web, and applied to the assigned web for printing; and
wherein at least during a partial phase of the acceleration of the assigned printing cylinder, each of the webs is stationary or is conveyed at an initial speed (Nᵢₙ) which is lower than the current speed of the assigned printing cylinder.

45. A web-fed printing machine, comprising:
a printing cylinder and a counter printing cylinder which together form a printing gap for printing onto a web;
an actuating device, by means of which at least the printing cylinder can be applied to and retracted from the web;
a cylinder drive for the printing cylinder and the counter printing cylinder;
at least one drawing means for the web;
a drawing means drive for the at least one drawing means;
and a control device for the actuating device, the cylinder drive and the drawing means drive;
wherein the control device is configured to actuate the actuating device using an actuating signal when starting up the web-fed printing machine and to actuate the cylinder drive and the drawing means drive, respectively using a nominal speed as a guiding variable, such that the printing cylinder is accelerated to a print-on speed (Nₚᵣᵢₙₜ₋ₒₙ) in a position retracted from the web and, at least during a partial phase of the acceleration of the printing cylinder, the web is stationary or is conveyed at an initial speed (Nᵢₙ) which is lower than the current speed of the printing cylinder.

46. The web-fed printing machine according to claim 45, wherein the printing machine comprises a folding apparatus comprising a drive of its own and the control device is configured to actuate the drive of the folding apparatus during the start-up, using a nominal speed as a guiding variable which corresponds to the speed of the web.

47. The web-fed printing machine according to claim 45, wherein:
the printing machine comprises: an inking unit which is assigned to the printing cylinder and comprises an ink applying roller; an actuating device for the ink applying roller; and a drive for the inking unit; wherein the cylinder drive can form the drive for the inking unit, and the ink applying roller can be applied to and retracted from the printing cylinder or a printing form cylinder assigned to the printing cylinder by means of the actuating device; and
the control device is configured to actuate the actuating device for the ink applying roller using an actuating signal when starting up the web-fed printing machine and to actuate the drive for the inking unit using a nominal speed as a guiding variable, such that the inking unit is accelerated to the synchronising speed (N_{synch}) while the printing cylinder is still retracted from the web and the ink applying roller is preferably only applied to the printing cylinder or the assigned printing form cylinder once the inking unit has been accelerated to the print-on speed (Nₚᵣᵢₙₜ₋ₒₙ).

48. The web-fed printing machine according to claim 45, wherein:
the printing machine comprises: a dampening unit which is assigned to the printing cylinder and comprises a moisture applying roller; an actuating device for the moisture applying roller; and a drive for the dampening unit; wherein the cylinder drive can form the drive for the dampening unit, and the moisture applying roller can be applied to and retracted from the printing cylinder or a printing form cylinder assigned to the printing cylinder by means of the actuating device; and the control device is configured to actuate the actuating device for the moisture applying roller using an actuating signal when starting up the web-fed printing machine and to actuate the drive for the dampening unit using a nominal speed as a guiding variable, such that the dampening unit is accelerated to the print-on speed (Nₚᵣᵢₙₜ₋ₒₙ) while the printing cylinder is still retracted from the web and the moisture applying roller is only applied to the printing cylinder or the assigned printing form cylinder once the dampening unit has been accelerated to the print-on speed (Nₚᵣᵢₙₜ₋ₒₙ).
